(19) United States
(12) Patent Application Publication
(10) Pub. No.: US 2011/0287145 A1
(43) Pub. Date: Nov. 24, 2011

(54) NUTRITION COMPOSITION CONTAINING OMEGA-3 FATTY ACIDS AND MCTS

(76) Inventor: Benedict Wallner, Runkel (DE)

(21) Appl. No.: 12/998,548

(22) PCT Filed: Oct. 28, 2009
(86) PCT No.: PCT/EP2009/007712

§ 371 Date: Aug. 2, 2011

(30) Foreign Application Priority Data
Oct. 29, 2008 (DE) 10 2008 053 682.2

(51) Int. Cl. A23L 1/30; A23L 1/305; A23L 1/302; A23L 1/308

(52) U.S. Cl. 426/72; 426/601; 426/613; 426/545

(57) ABSTRACT

A nutrition composition containing fatty acids, proteins, carbohydrates, and additional components, wherein the fatty acids include a two-component fatty acid mixture, the first of which is of omega-3 fatty acids in a fraction of 25% by weight, and the second of which is of medium chain fatty acids having 8-12 carbon atoms in a fraction of at most 50% by weight with respect to the total weight of the fatty acids.

### BACKGROUND OF THE INVENTION

1. Field of the Invention

This invention relates to a nutritional composition containing fatty acids, proteins, carbohydrates, and other components, which, as a complete food, can be used for short-term or longer-term consumption or can also be used in a dieting context.

2. Discussion of Related Art

European Patent Reference EP 0 843 972 B1 discloses a nutritional composition, which is for treating the metabolic syndrome and is based on the combination of so-called medium chain fatty acids (MCTs) with 8 or 10 carbon atoms at a high percentage by weight of 55 to 95 wt % and omega-3 fatty acids at a low percentage by weight of 5 to 25 wt %. A nutritional composition of this kind tailored to treatment of the metabolic syndrome, however, seems unsuitable for use as a complete food and/or for weight loss in a dieting context.

### SUMMARY OF THE INVENTION

One object of this invention is to provide a nutritional composition of the type mentioned above but which, as a complete food, supplies all of the nutrients and energy required by the human body, and at the same time activates the burning of fatty acids in the liver and therefore results in a reduction of the fat mass in the fatty tissues and to a reduction of lipid levels in the blood.

This object is attained according to the invention with a nutritional composition according to the defining characteristics described in this specification and in the claims.

Advantageous embodiments and modifications of this invention are discussed in the specification and in the claims.

One proposal according to this invention is based on the fatty acids of the nutritional composition according to this invention being essentially composed of or comprising two components. The first component is of a significantly high percentage of omega-3 fatty acids of at least 25 wt % and the second component is of medium chain fatty acids with 8 to 12 carbon atoms at a percentage of at most 50 wt %, and the respective proportions of the components each measured relative to the total weight of fatty acids in the nutritional composition.

### DETAILED DESCRIPTION OF THE INVENTION

One optimum body composition from a health standpoint is constituted by a minimum of fat mass in the fatty tissues and a maximum of well-trained muscle mass. As a rule, it is only possible to achieve such a state through maximum endurance training in top athletes, such as long-distance runners. In untrained people with an increased fatty tissue mass, such as overweight or obesity, the problem is for one, for example as part of a diet featuring extremely low-calorie food, it is possible to achieve a gradual melting away of the excess fat mass, but due to a lack of training and due to the diet itself, a loss in muscle mass occurs at the same time. On the other hand, an uncontrolled training program does lead to increased calorie requirement of the musculature. At the same time, however, poor oxygen uptake results primarily in the burning of carbohydrates, such as glucose and glycogen, and not fatty acids from the fatty tissues. This process does in fact lead to improved fitness, but not to the desired health-enhancing effect of a decrease in the excess fat mass in the fatty tissues.

This problem can be overcome by using the nutritional composition according to this invention. Due to its high percentages of at least 25 wt % of omega-3 fatty acids and up to 50 wt % of medium chain fatty acids with 8 to 12 carbon atoms, the nutritional composition according to this invention is a very fatty food, which can be used in liquid form as a beverage, for example, but can also be used in a paste-like form, such as in yogurt, pudding, dressings, ice creams, and sauces. It is also possible for it to be in a dried, for example powdered, dosage form. Due to the high fat content, it produces a very high satisfaction value, thus allowing the daily quantity as a hypocaloric food to be easily tolerated without hunger pangs.

One combination on which this invention is based, composed of at least 25 wt % of omega-3 fatty acids and at most 50 wt % of medium chain fatty acids with 8 to 12 carbon atoms, which are also referred to as MCTs, results in a maximum activation of the burning of fatty acids in the liver. This activation of lipometabolism in the liver indirectly results in a decrease in the fat mass in the fatty tissues and a reduction of the lipid levels in the blood, in particular a reduction of the fatty acids and triglycerides in the blood.

In the context of this invention, the inventors have discovered that consuming the nutritional composition according to this invention causes the body, within a short time, to switch over to fat burning mode, specifically resulting in a decrease in the fat mass in the fatty tissues and a reduction of the lipid levels in the blood.

A particularly effective fat burning in the liver is achieved if consumption of the nutritional composition according to this invention is accompanied by an activation of fat burning in the musculature through aerobic training, particularly if direct measurement of oxygen and carbon dioxide concentrations in the exhaled breath is used to monitor the training, so that the person remains in the aerobic range and therefore uses only fatty acids to produce energy in the musculature.

In addition to the immediate positive effects on health due to the reduction of risk factors, in particular overweight, obesity, and elevated lipid levels in the blood, the use of the nutritional composition according to this invention achieves a lasting improvement in the metabolic activity at rest, the so-called basal metabolic rate, and therefore also achieves a resistance to the tendency to regain weight, such as the yo-yo effect that frequently occurs when dieting.

In the context of this invention, the fatty acids of the nutritional composition according to this invention are understood to be in the form of both free fatty acids and esterified fatty acids. They can be triglyceride-bonded or can also be in the form of fatty acid ethyl esters.

Preferably, the omega-3 fatty acids used in the nutritional composition according to this invention are eicosapentaenoic acid (EPA), docosahexaenoic acid (DHA), and alpha-linolenic acid (ALA), which can be used both individually and in various mixtures depending on their availability.

The nutritional composition also contains a significantly higher percentage of omega-3 fatty acids than omega-6 fatty acids, and is regarded as particularly advantageous if the fatty acids of the nutritional composition according to this invention contain at most 6.5 wt % of omega-6 fatty acids.

A nutritional composition that is particularly suitable for attaining objects of this invention stated above contains approximately 50 to 60 en % fatty acids, 15 to 25 en % proteins, and 20 to 30 en % carbohydrates.

The unit en % expresses the theoretical percentage of the respective component in the total energy content of the nutritional composition, based on the assumption of a full utilization of the energy content of the nutritional composition in the organism.

The dual principle on which the nutritional composition according to this invention is based, namely a combination of a high percentage of omega-3 fatty acids and medium chain fatty acids with 8 to 12 carbon atoms (MCTs) is also suitable for treatment of various indications, such as metabolic diseases, diabetes, obesity, inflammatory diseases of all types due to inhibition of eicosanoids, cardiovascular diseases due to the anti-arrhythmic effect of eicosapentaenoic acid (EPA), increased brain performance for infant intelligence development through administration of high dosages of DHA and for prevention of dementia, antipsychotic effect, antiproliferative effect in the context of a cancer diet, which can also be supplemented as needed with a series of additional components that can be added to the nutritional composition according to this invention.

It is thus possible for the nutritional composition according to this invention to contain additional components, among other things dietary fiber, in order to increase the regularity of the digestive system.

An improved transport of fatty acids into the mitochondria can be achieved through the addition of carnitine as an additional component of the nutritional composition according to this invention.

Another possible component of the nutritional composition according to this invention is a lecithin fraction composed of or comprising so-called omega-3 eggs, such as a lecithin-(phosphatidyl choline) fraction from the eggs of hens that have been fed an omega-3 rich diet. It is known that when hens are fed flax seeds and/or fish meal, they produce high quantities of omega-3 fatty acids, namely ALA, EPA, and DHA in the sn-2 position (β position) of the egg lecithin. It is thus possible to enrich each hen egg with 150 to 200 mg of omega-3 fatty acids. The lecithin fraction, the raw lecithin, can then be extracted from these omega-3 eggs. This feed-based approach is used in Germany and also in other countries to commercially produce omega-3 eggs. One biological advantage of omega-3 lecithin is that after absorption in the small intestine, the form circulating in the blood is precisely the one that remains in the body over the long term in the form of omega-3 fatty acid, namely in the form of a membrane phospholipid, which in turn is integrated into all cell systems of the body, including those of the central nervous system.

If the nutritional composition according to this invention is to also be used as a liquid beverage, then it is also possible to use the omega-3 lecithin as a stand-alone emulsifier. In the context of this invention, the lecithin-(phosphatidyl choline) fraction from hen eggs is provided in liquid form at a concentration of between 0.01 g and 20 g/100 ml of nutritional composition according to this invention.

Because both omega-3 fatty acids and MCT fatty acids have been recently available in powdered form, it is also possible for the composition according to this invention to be provided in a powdered form.

Another possible component of the nutritional composition according to this invention includes tocotrienols. Vitamin E is known to be composed of 8 isoforms with different biological activities, namely alpha, beta, gamma, and delta tocopherol and alpha, beta, gamma, and delta tocotrienol. According to recent studies, tocotrienols in particular are significantly more effective than the alpha tocopherol that has been used most often up to this point, which is also available in synthetic form. There is a tocotrienol extract available on the market, which has a very powerful antioxidant effect and is neuroprotective, for example in Alzheimer's disease and stroke situations. An anti-cancer effect has just been demonstrated and some studies have demonstrated a reduction of cholesterol.

Tocotrienols can be used as a stand-alone antioxidant for preserving the nutritional composition according to this invention, and they should be used in a concentration of 0.01 to 10 g/100 ml of a liquid nutritional composition.

Another possible component of the nutritional composition according to this invention is ubiquinone. Ubiquinone, the so-called vitamin Q10, is an essential substance for energy production (electron transport) in the mitochondria of the cells. In addition, ubiquinone is a very important fat-soluble antioxidant. It is also produced in small quantities in humans as a byproduct of sterol synthesis (main product cholesterol). Similar to cholesterol, however, it is also absorbed with food. The supply of it in food is essential for body function. Ubiquinone is in particular essential for tissues that consume large amounts of energy such as the heart muscle. Accordingly, very low levels have been measured in the heart muscle in cases of cardiac insufficiency. Past studies have demonstrated an improvement in cases of cardiac insufficiency through administration of high dosages of ubiquinone. There are also indications that ubiquinone could be necessary for brain function. An influence on diseases such as arteriosclerosis has also been described. Up to now, the main problem with administering ubiquinone has been extreme lipophilia that results in a low resorption of less than 5% in tablet form. In the context of this invention, the nutritional composition has been in the form of a liquid beverage enables optimum emulsion of the ubiquinone and leads to an enormous increase in resorption so that it is possible for the first time to observe truly relevant plasma and tissue levels in the human body. Preferably, approximately 0.001 to 5 g/100 ml should be added to the liquid nutritional composition.

Other possible components of the nutritional composition according to this invention include extracts from red rice or green tea.

Red rice is the result of an inoculation of rice with a fungus, the monascus ruber, which produces a red color. This recipe comes from traditional Chinese medicine, and because of its bacteria-inhibiting action, the dried powder of ground red rice is enthusiastically embraced for use as a preservative in foods. In traditional Chinese medicine, red rice has also been used to treat diarrhea. Red rice has also been recently demonstrated to have a cholesterol-reducing action, which is due to the cholesterol synthesis inhibitors (HMG CoA reductase inhibitor and statins) generated by the fungus. In addition to the cholesterol level-reducing action, red rice extract can also be used as a preservative in the nutritional composition according to this invention. In the context of this invention, it is preferable to use a red rice extract dosage of approximately 0.001 to 10 g/100 ml of liquid nutritional composition.

In addition to caffeine, green tea extract also contains a series of highly effective antioxidants such as quercetin, epigallocatechin, and the like. Caffeine is very important for releasing fatty acids from the fatty tissues and can therefore have a positive influence on the weight loss achievable using the nutritional composition according to this invention.

Other possible components of the nutritional composition according to this invention include hill phospholipids. By contrast with fish oil, the liquid extract from krill is primarily composed of phospholipids that essentially contain EPA and DHA. Krill oil is therefore suitable not only as a source of omega-3 fatty acids that are particularly easy for the body to digest, but also in the context of the nutritional composition according to this invention, as an emulsifier for the nutritional composition that is in liquid form and at the same time has a high content of omega-3 fatty acids. This invention proposes adding krill phospholipids to a liquid nutritional composition in a dosage of approximately 0.01 to 20 g/100 ml.

Other possible components of the nutritional composition according to this invention include plant sterols such as sitosterol/-ester and sitostanol/-ester, which are already used as cholesterol-reducing products in the food sector.

Plant sterols reduce cholesterol absorption in the small intestine. They can achieve an up to 15% reduction of LDL cholesterol. Preferably, sitostanol/-esters are used in a dosage of between 0.01 and 10 g/100 ml of the liquid nutritional composition.

Cholestyramine or colestipol, which function as anion-exchange resins, can also be provided as additional components of the nutritional composition according to this invention. Because anion-exchange resins of this kind swell and form a gel with the addition of water, they can be used as part of a gelled or paste-like dosage form of the nutritional composition according to this invention, for example in the form of a yogurt or pudding. This invention proposes adding approximately 0.1 to 10 g/100 ml to the gelled nutritional composition according to this invention.

Ground plantago, guar flour, and dried and/or ground guava, mango, and/or papaya fruits can be used as additional components of the nutritional composition according to this invention.

Plantago (Indian psyllium) is the seed from a South Asian plant with a very high water-binding capacity. Ground plantago is used as a soluble and insoluble dietary fiber for treatment of constipation. In the swollen state, plantago also binds to bile acids and at high dosages, can achieve a 10 to 15% reduction of LDL cholesterol. Through complexing of oligosaccharides, plantago also causes delayed carbohydrate absorption and therefore an improvement in glucose tolerance. If the nutritional composition according to this invention is in a gel or paste-like form, such as in the form of a yogurt or pudding, then previously swollen plantago can be used as a gelling and binding agent. A dosage of between 0.1 and 10 g/100 ml of nutritional composition is suggested.

Guar flour can also be used in a similar way because its bile acid-binding action also causes it to have a positive impact on the cholesterol level and to exert a retarding action on KH resorption.

Guava, mango, and papaya fruits also contain abundant amounts of soluble and insoluble dietary fiber, which allows them, after being dried and ground, to be added in powder form to the liquid or paste-like nutritional composition according to this invention. The dried fruits are also quite tasty and can also be used as flavor enhancers. Dosages of between 0.1 and 10 g/100 ml of the nutritional composition according to this invention are also possible.

Another component of the nutritional composition according to this invention can include an extract of Garcinia cambogia. This South Asian and Southeast Asian tropical fruit has a sour taste due to a high content of hydroxycitrate. This substance has been clearly demonstrated in vitro to have an inhibiting effect on fatty acid synthesis from carbohydrates, which is the basis for the assumption that it will have an obesity inhibiting effect. In the context of this invention, it is possible to use dosages of between 0.1 and 15 g/100 ml of liquid nutritional composition.

This invention also proposes using another component in the form of a carbohydrate that functions as a sweetener and includes glucose and fructose units bonded via an α-1,6 glucosidic bond. Such a carbohydrate is available in the form of isomaltulose, such as known by the trade name Palatinose™.

The above-mentioned components can be used both individually and in combination, depending on the given indications. In the context of this invention, it is in particular conceivable to produce a variety of nutritional compositions that are in fact all based on the dual principle of a combination of omega-3 fatty acids at a percentage of at least 25 wt % and medium chain fatty acids with 8 to 12 carbon atoms at a percentage of at most 50 wt %, but that vary in the selection of the additional components, depending on whether the effect is achieved primarily by a complete food, a dietetic food, or a means or way for treating particular medical indications.

In addition to the above-explained additional components, it is also possible to use a multitude of other components individually or in combination, for example lycopene, beta-carotene, alpha-carotene, lutein, zeaxanthin, cryptoxanthin, beta-cryptoxanthin, canthaxanthin, antheraxanthin, d-limonene, gingerol, allyl sulfides, alliin, allicin, sulforaphane, silymarin, ellagic acid, p-coumaric acid, ferulic acid, sapienic acid, vanillic acid, gallic acid, protocatechuic acid, syringic acid, curcumin, saponin, phloretin, hesperidin, naringenin, catechin, epicatechin, procyanidin, quercetin, camphorol, apigenin, luteolin, flavonol, genistein, formononetin, daidzein, malvidin, delphinidin, cyanidin, alpha lipoic acid, and caffeine.

### EXEMPLARY EMBODIMENT

A nutritional composition according to this invention in liquid form includes 9.2 g of fatty acids, 9.3 g of carbohydrates, and 7.5 g of protein, with the carbohydrates entirely composed of sugar. The fatty acids include 5.13 g of saturated fatty acids, 1.13 g of monounsaturated fatty acids, and 2.94 g of polyunsaturated fatty acids. In addition, the nutritional composition contains 1.0 g of dietary fiber, in particular inulin and oligofructose. In absolute terms, the fatty acid fraction includes 0.48 g of EPA, 0.48 g of DHA, and 1.44 g of ALA, corresponding to 26.1 wt % relative to the total weight of fatty acids and 4.5 g of medium chain fatty acids with 8 to 12 carbon atoms, corresponding to 48.9% of the total weight of fatty acids.

It also contains omega-6 fatty acids in a quantity of 0.56 g, corresponding to 6.1 wt % and omega-9 fatty acids in a quantity of 0.34 g, corresponding to 3.7 wt %.

The energy allocation of the composed nutritional composition was 20 en % proteins, 55 en % fatty acids, and 25 en % carbohydrates.

The composed nutritional composition was prepared in the form of a liquid beverage and can be used as a complete food for continuous nourishment and also as part of a diet.

1. A nutritional composition containing fatty acids, proteins, carbohydrates, and other components, wherein the fatty acids include a two-component fatty acid mixture with a first component of omega-3 fatty acids at a percentage of at least 25 wt % and a second component of medium chain fatty acids with 8 to 12 carbon atoms at a percentage of at most 50 wt %, each relative to a total weight of fatty acids.

2. The nutritional composition as recited in claim 1, wherein the fatty acids are in a form of free fatty acids and/or esterified fatty acids.

3. The nutritional composition as recited in claim 2, wherein the fatty acids are triglyceride-bonded or are in a form of fatty acid ethyl esters.

4. The nutritional composition as recited in claim 3, wherein the omega-3 fatty acids are of eicosapentaenoic acid (EPA), docosahexaenoic acid (DHA), and/or alpha-linolenic acid (ALA).

5. The nutritional composition as recited in claim 4, wherein the fatty acids contain at most 6.5 wt % of omega-6 fatty acids.

6. The nutritional composition as recited in claim 5, wherein the nutritional composition contains 50 to 60 en % fatty acids, 15 to 25 en % proteins, and 20 to 30 en % carbohydrates.

7. The nutritional composition as recited in claim 6, wherein the nutritional composition contains dietary fiber.

8. The nutritional composition as recited in claim 7, wherein the nutritional composition contains another component in a form of a lecithin-(phosphatidyl choline) fraction from a hen egg.

9. The nutritional composition as recited in claim 8, wherein the nutritional composition contains other components in the form of tocotrienols.

10. The nutritional composition as recited in claim 9, wherein the nutritional composition contains another component in the form of ubiquinone.

11. The nutritional composition as recited in claim 10, wherein the nutritional composition contains other components in forms of extracts of red rice and/or green tea.

12. The nutritional composition as recited in claim 11, wherein the nutritional composition contains other components in a form of krill phospholipids.

13. The nutritional composition as recited in claim 12, wherein the nutritional composition contains other components in a form of plant sterols, cholestyramine d-limonene, or colestipol.

14. The nutritional composition as recited in claim 13, wherein the nutritional composition contains other components in forms of ground plantago, guar flour, and/or dried and ground guava, mango, and/or papaya fruits.

15. The nutritional composition as recited in claim 14, wherein the nutritional composition contains another component in a form of an extract of Garcinia cambogia.

16. The nutritional composition as recited in claim 15, wherein the nutritional composition contains another component in a form of a carbohydrate composed of a glucose unit and a fructose unit that are bonded via an α-1,6 glucosidic bond.

17. The nutritional composition as recited in claim 1, wherein the fatty acids are triglyceride-bonded or are in a form of fatty acid ethyl esters.

18. The nutritional composition as recited in claim 1, wherein the omega-3 fatty acids are of eicosapentaenoic acid (EPA), docosahexaenoic acid (DHA), and/or alpha-linolenic acid (ALA).

19. The nutritional composition as recited in claim 1, wherein the fatty acids contain at most 6.5 wt % of omega-6 fatty acids.

20. The nutritional composition as recited in claim 1, wherein the nutritional composition contains 50 to 60 en % fatty acids, 15 to 25 en % proteins, and 20 to 30 en % carbohydrates.

21. The nutritional composition as recited in claim 1, wherein the nutritional composition contains dietary fiber.

22. The nutritional composition as recited in claim 1, wherein the nutritional composition contains another component in a form of a lecithin-(phosphatidyl choline) fraction from a hen egg.

23. The nutritional composition as recited in claim 1, wherein the nutritional composition contains other components in the form of tocotrienols.

24. The nutritional composition as recited in claim 1, wherein the nutritional composition contains another component in the form of ubiquinone.

25. The nutritional composition as recited in claim 1, wherein the nutritional composition contains other components in forms of extracts of red rice and/or green tea.

26. The nutritional composition as recited in claim 1, wherein the nutritional composition contains other components in a form of krill phospholipids.

27. The nutritional composition as recited in claim 1, wherein the nutritional composition contains other components in a form of plant sterols, cholestyramine d-limonene, or colestipol.

28. The nutritional composition as recited in claim 1, wherein the nutritional composition contains other components in forms of ground plantago, guar flour, and/or dried and ground guava, mango, and/or papaya fruits.

29. The nutritional composition as recited in claim 1, wherein the nutritional composition contains another component in a form of an extract of Garcinia cambogia.

30. The nutritional composition as recited in claim 1, wherein the nutritional composition contains another component in a form of a carbohydrate composed of a glucose unit and a fructose unit that are bonded via an α-1,6 glucosidic bond.
